(19) United States
(12) Patent Application Publication
(10) Pub. No.: US 2003/0108032 A1
(43) Pub. Date: Jun. 12, 2003

(54) Line switching method and apparatus, and network device

(76) Inventor: Noriyasu Kato, Shinagawa-ku (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/190,886

(22) Filed: Jul. 3, 2002

(30) Foreign Application Priority Data
Dec. 11, 2001 (JP) 2001-376725
Dec. 11, 2001 (JP) 2001-376727
Dec. 11, 2001 (JP) 2001-376729

(51) Int. Cl. H04L 12/66

(52) U.S. Cl. 370/352

(57) ABSTRACT

A method and apparatus for assigning either a public network or a digital communication network to a communication apparatus having a telephone function. The method includes determining whether the public network is available, determining whether a user of the communication apparatus wishes to connect the communication apparatus to the public network, connecting the communication apparatus to the public network when the public network is determined to be available and the user wishes to connect the communication apparatus to the public network, and, otherwise, connecting the communication apparatus to the digital communication network.

### BACKGROUND OF THE INVENTION

1. Field of the Invention

The present invention relates to network devices, and more particularly to switches and routers.

2. Description of the Related Art

In the following description, a “switch” is one type of a network device which serves to read a Media Access Control (MAC) address of a destination terminal and to send a packet to a port connected to the terminal. A “router” is another type of network device which uses a network address to identify a destination terminal so as to connect two Local Area Networks (LANs) to each other or connect a LAN and a Wide Area Network (WAN) to each other.

The recent spread of LANs and WANs allows many network devices, such as personal computers (PC's), hubs, switches, and routers (“nodes” or “agents” especially for hubs) to connect to a network and its subnetworks for information sharing and frequent communications.

These network devices are typically required to be not only multifunctional to deal with recent various communication modes, but also possess a high processing capability to communicate with more communication devices with larger amounts of communication.

For instance, recently developed switches and routers have realized a multifunction by possessing a Voice over Internet Protocol (VoIP) function. VoIP is a protocol for sending a voice signal using an Internet Protocol (IP) network. The VoIP achieves a telephone communication by including a digitized voice signal into a packet, superimposing it onto a packet for an Ethernet, transferring the superimposed packet through the Ethernet, and converting it into analog data at a destination terminal. The VoIP function is advantageous in that it uses an IP network having a high duty cycle to reduce the telephone charge rather than using an analog communication line with expensive telephone charges.

However, conventional switches and routers continue to have insufficient functionality to support a multifunction capability. For instance, in an attempt to make a telephone communication efficient, such as using the VoIP, it is necessary that network use among users is not restricted. In other words, such an attempt requires a function that extends the VoIP network and maintains communications through the existing telephone network. Thus, a line must have the ability to switch freely and easily in accordance with a user's choice, particularly, in a circumstance where multiple telephones are used.

A conventional modem is an insufficient solution for this problem. The conventional modem is connected between a telephone network and a telephone, and achieves data communication by detecting a status of the telephone, such as an ‘off-hook’ state, to avoid an interference with a voice communication. Line switching using a modem causes insufficient switching control for multiple telephones since there is a one-to-one correspondence between the telephone and the telephone network. It may be conceivable to provide a control terminal among multiple telephones and the telephone network, allowing the control terminal to receive a call and then to send the call to a designated line, as in a private branch exchange (PBX). However, such a structure makes a line switching apparatus dramatically expensive.

### SUMMARY OF CERTAIN INVENTIVE EMBODIMENTS

Certain embodiments of the present invention provide a line switching method and apparatus, as well as a network device, for freely switching a line between a telephone network and another line other than the telephone network, such as a VoIP network, in accordance with a user's choice.

One embodiment of the invention includes a line switching method for assigning one of a public network and a digital communication network, different from the public network, to a communication apparatus having a telephone function. The method comprises determining whether the public network is available, and determining whether a user of the communication apparatus desires to connect the communication apparatus to the public network or the digital communication network. The method further comprises connecting the communication apparatus to the public network when it is determined that the public network is available and the user wishes to connect the communication apparatus to the public network, or connecting the communication apparatus to the digital communication network when it is determined that the public network is unavailable or the user does not wish to connect the communication apparatus to the public network. Thus, the communication apparatus is connected to the public network when the public network is available and when the user wishes to do so, otherwise the communication apparatus is connected to the digital communication network.

The method allows for switching a communication line between the public line and the digital communication line, based on the availability of the public network and a user's choice, rather than based on the content of a call, thereby providing a structure less expensive than a PBX.

The communication apparatus can be a telephone, facsimile machine, etc. The public network can be, for example, a telecommunication network for providing multiple and unspecified users with communication services including, for example, a Public Switched Telephone Network (PSTN) as a public telephone exchange network.

The communication apparatus may have a key entry part, and determining whether the user desires connection to the public network can be based on an entry of a specific key (such as an asterisk button on a touch-tone phone) in the communication apparatus. Connecting the communication apparatus to the digital network can additionally allow the communication apparatus to communicate using a Voice over Internet Protocol. Alternately, the communication apparatus may communicate through the digital communication network using, for instance, the VoIP.

Determining the availability of the public network may include determining a state of the communication apparatus, the state including a ringing to the communication apparatus. For example, when there are two communication apparatuses and a ringing is sent to one of them through the public network, the other communication apparatus cannot use the public network.

The communication apparatus may have a key entry part, and determining whether the user of the communication apparatus wishes to connect the communication apparatus to the digital communication network can be based on an entry of a specific key in the communication apparatus, thus determining whether the digital communication network is to be connected, rather than whether the public network is to be connected. Such a structure eliminates the requirement of the user of the communication apparatus to enter any key other than a destination number unless he/she desires to use the digital communication network. Therefore, the telephone communication is available through the public network by simply entering a phone number. Such a phone number without a prefix is convenient especially in the event of an emergency. For example, in the event of an emergency such as fire, the user of the communication apparatus may lose concentration and not dial a prefix, and wherein emergency numbers such as ‘911’ do not require a prefix to be entered.

One embodiment of the invention includes a method of assigning one of first and second networks to a communication apparatus, wherein the method comprises determining whether the first network is available, determining whether a user of the communication apparatus wishes to connect the communication apparatus to the first network, connecting the communication apparatus to the first network when it is determined that the first network is available and when the user wishes to connect the communication apparatus to the first network, and connecting the communication apparatus to the second network when the public network is determined to be unavailable or when the user does not wish to connect the communication apparatus to the first network.

A line switching apparatus of another aspect of the invention includes a switching part for switching a communication line between a first and a second network, wherein one of the first and second network is to be connected to the communication apparatus, and a control part for controlling the switching part so that the communication apparatus is connected to the first network when the control part determines that the first network is available, and to the second network when the control part determines that the first network is unavailable. According to the line switching apparatus, the mechanical switching part can be less expensive than a PBX and operate similar to the previously described line switching method. The first network can be a public network, the second network can be a digital communication network, and the communication apparatus can have a telephone function, wherein the line switching apparatus can have a digitization part for digitizing a voice signal entered from the communication apparatus so as to transfer the voice signal through the second network.

The control part can determine whether a user of the communication apparatus wishes to connect the communication apparatus to the first network, and the control part can control the switching part so that the communication apparatus is connected to the first network when the control part determines that the user wishes to connect the communication apparatus to the first network. Thereby, the user may maintain a service available through the first network and may use the second network when he/she thinks that the second network is more advantageous.

The first network may be a public network, the second network may be a digital communication network, and the communication apparatus may have a telephone function, wherein the line switching apparatus may further include a detector for detecting, through the switching part, a state of the communication apparatus. The state can include a ‘ringing’ to the communication apparatus, wherein the control part determines an availability of the public network based on a detection result from the detector. The detector can thus detect a ‘ringing,’ thereby avoiding a situation where the communication apparatus selects the public network when another communication apparatus receives the ‘ringing.’

The line switching apparatus may further include a first detector for detecting an ‘on-hook’ and an ‘off-hook’ state of the communication apparatus, and a second detector for detecting an entry of a specific key from the communication apparatus, wherein the first network is a public network, and the second network is a digital communication network. The control part can control the switching part so that the communication apparatus is connected to the first network when the control part determines that the first network is available and when the second detector detects the specific key entered from the communication apparatus, and so that the communication apparatus is connected to the second network when the control part determines that the first network is unavailable or when the second detector does not detect the specific key entered from the communication apparatus.

For example, the first detector can be a subscriber line interface circuit (SLIC), and the second detector can be a CODEC (coder/decoder). The second detector can include a digitization part for digitizing a voice signal entered from the communication apparatus so as to transfer the voice signal through the second network. Such a structure may simplify a structure of the apparatus.

A network device of still another aspect of the invention includes a first port connectable to a first communication apparatus having a telephone function, and a second port connectable to a second communication apparatus, wherein the second communication apparatus is a different type than the first communication apparatus. The second port can allow the second communication apparatus to communicate via a digital communication network. The network device may also include a third port, connectable to a public network for sending a voice signal obtained from the telephone function in the first communication apparatus, a digitization part for digitizing the voice signal from the first communication apparatus, thereby enabling the voice signal to be transferred through the digital communication network, and a switching part, connected to the first communication apparatus. The switching part can assign the public network or the digital communication network to the first communication apparatus, and a control part can control the switching part so that the communication apparatus is connected to the public network when the control part determines that the first network is available and that a user of the first communication apparatus wishes to use the public network, and so that the communication apparatus is connected to the digital communication network when the control part determines that the public network is unavailable or that the user does not wish to connect the communication apparatus to the public line.

The network device may include at least two first ports. In this case, if it is determined that the public network is unavailable when another communication apparatus is using the public network. The network device may be a switch or router, as previously described.

The network device may further include a detector for detecting, through the switching part, a state of the communication apparatus including a ‘ringing’ of the communication apparatus, wherein a control part determines an availability of the public network based on a detection result of the detector. Alternatively, the network device may further include a detector, connected to the switching part and the public network, for detecting a specific key entered from the communication apparatus, wherein the control part determines, based on a detection result from the detector, whether a user of the communication apparatus wishes to connect the communication apparatus to the second network.

Other objects and further features of the present invention will become readily apparent from the following description of certain embodiments with reference to accompanying drawings.

### BRIEF DESCRIPTION OF THE DRAWINGS

FIG. 1 is a block diagram of one embodiment of a network system.

FIG. 2 is a block diagram of one embodiment of a line switching apparatus for implementation in the network system of FIG. 1.

FIG. 3 is a flowchart illustrating one embodiment of a method of operation of the line switching apparatus shown in FIG. 2.

FIG. 4 is a block diagram of another embodiment of a line switching apparatus of the network device of FIG. 1.

FIG. 5 is a flowchart illustrating one embodiment of a method of operation of the line switching apparatus shown in FIG. 4.

FIG. 6 is a block diagram of yet another embodiment of a line switching apparatus of the network device of FIG. 1.

FIG. 7 is a flowchart illustrating one embodiment of a method of operation of the line switching apparatus shown in FIG. 6.

### DETAILED DESCRIPTION OF CERTAIN EMBODIMENTS

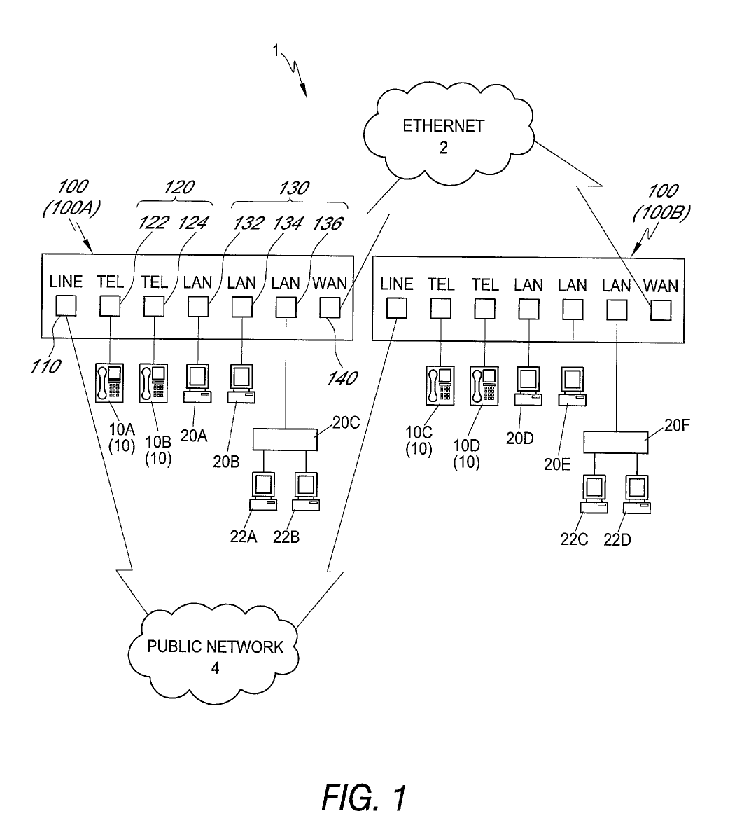

A description will now be given of a network system 1 and network devices 100 of the present invention with reference to accompanying drawings. FIG. 1 is a block diagram of the network system 1. The network system 1 comprises, as illustrated, an Ethernet 2, a public network 4, and a pair of network devices 100 (100A and 100B are used to distinguish between them).

In one embodiment, the network 2 is composed of a WAN, however, the network 2 can be a network for digital communications, such as an ISDN or SDH.

In one embodiment, the public network 4 is a Public Switched Telephone Network, or public telephone exchange network.

In one embodiment, the network device 100 is a switch, comprising a combination of LAN and WAN functions and compatible with a broad band, however the network device does not exclude a router and other network devices. Each network device 100 comprises a LINE port 110, multiple TEL ports 120, multiple LAN ports (or MDI-X ports) 130, and a WAN port (or MDI port) 140.

The LINE port 110 is connectable to the public network 4 and includes an RJ11 in this embodiment. The RJ11 is one type of modular-jack connector for use with a connection to an analog-line telephone and modem, and has six contacts. The LINE port 110 constitutes part of line switching apparatus 200, which will be described in further detail hereinafter.

Two TEL ports 120 (i.e., TEL ports 122 and 124) are provided, and each TEL port 120 is connected to one of the telephones 10 (10A and 10D are used to distinguish between them), wherein the telephones are touch-tone phones having a key entry part. However, it will be appreciated that the communication apparatus can be any apparatus having a telephone or similar function (such as a facsimile or a modem). The telephones 10A and 10B may have different phone numbers, or be assigned the same number with a different extension. Each of the TEL ports 122, 124 also include a RJ11 in this embodiment, and constitute part of the line switching apparatus 200, which will be described later.

Each of the LAN ports 130 and the WAN port 140 can be connected, for example, to an Unshielded Twisted Pair (UTP) cable. Through the UTP, the LAN ports 130 can be connected to network devices 20 (20A-20F are used to distinguish between them). The network devices 20 include PCs 20A, 20B, 20D, 20E, 22A-22D, and hubs 20C, 20F. However, the network devices can be, for example, a hub, a switch, a router, any other concentrator, a repeater, a bridge, a gateway device, a PC, a server, or a wireless interconnecting device (e.g., an access point as an interconnecting device for wireless LAN).

The WAN port 140 is connected to a WAN connecting device (not shown) (such as an ADSL modem) and includes an RJ45 connector in one embodiment. The RJ45 connector is another modular-jack connector type for use with a cable connected to a 10BASE-T cable and an ISDN device, and has eight contacts. The WAN port 140 also constitutes part of the line switching apparatus 200, which will be described later.

The network device 100 can include a display device (not shown), and the display device may include a plurality of light emitting diodes (LED's) for displaying a communication status. For instance, the display device can detect, identify, and indicate a Full Duplex link, a Half Duplex link, a 100BASE-TX link, a 100BASE-T link, a system error, and/or a power supply error.

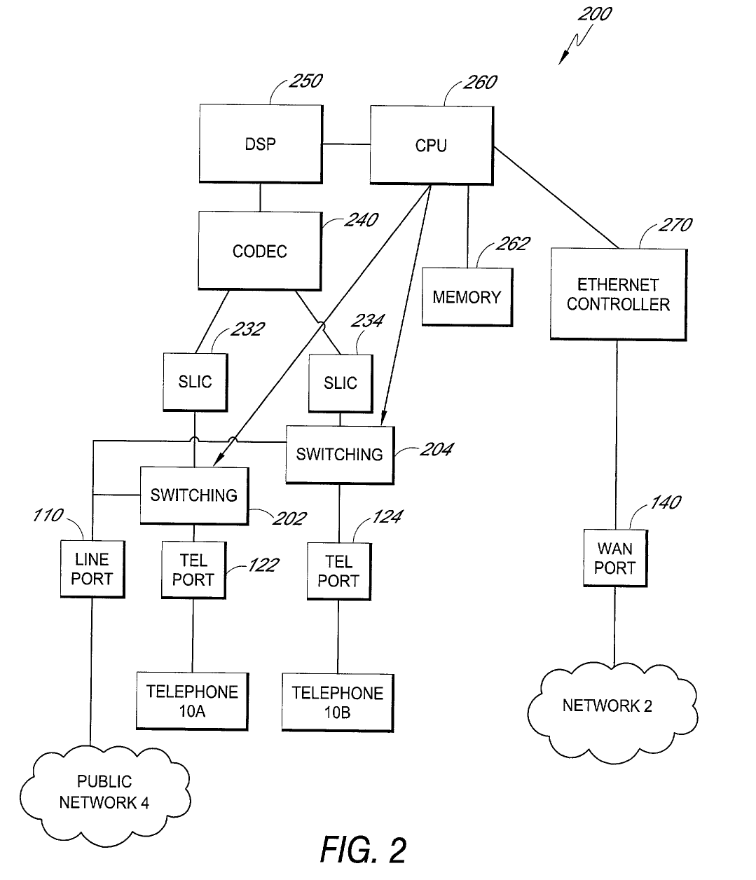

FIG. 2 is a block diagram of the line switching apparatus 200. With reference to FIG. 2, a description will now be given of the line switching apparatus 200 for assigning either the network 2 or the public line 4 to the telephone 10. As illustrated, the line switching apparatus 200 comprises, in addition to the above ports 110, 122, 124, and 140, switching parts 202, 204, Subscriber Line Interface Circuits (SLIC's) 232, 234, a CODEC 240, a digital signal processor (DSP) 250, a CPU 260, a memory 262, and an Ethernet controller 270.

The switching parts 202, 204 can mechanically switch a line between the network 2 and the public network 4 for a corresponding one of the telephones 10A-B, wherein the CPU 260 controls the switching. Due to the presence of the mechanical switching parts 202, 204, the network device 200 in the present embodiment may switch a line much less expensively than the PBX. The switching parts 202, 204 connect the telephones 10 to corresponding SLIC's 232, 234 when a predetermined voltage level is applied to the switching parts 202, 204. Thereby, the switching parts 202, 204 connect the telephones 10 to the public network 4 when the predetermined voltage is not applied to these switching parts 202, 204, for example, during a power supply failure.

The SLIC's 232, 234 can each detect an ‘off-hook’ state (where a receiver (not shown) of the telephone 10 has been picked up) and an ‘on-hook’ state (where the receiver (not shown) of the telephone has been returned to the telephone base) for corresponding telephones 10A-B. The SLIC's 232, 234 may use any structure known in the art, and a detailed description thereof is omitted.

The CODEC 240 can include an analog-to-digital (A/D) converter function for digitizing an analog voice signal entered from the telephone 10, and a digital-to-analog (D/A) converter function for converting a digital signal extracted from the DSP 250 into an analog voice signal.

In one embodiment, the CODEC 240 detects whether a specific Dual Tone Multi Frequency (DTMF) has been entered from a touch-tone phone. The CODEC 240 thus has a DTMF detecting function in one embodiment, but if the CODEC 240 does not have such a function, a DTMF receiver may be connected. The detection may use a known pulse tone detector, for example. The DTMF, referred to also as a push or tone sound, is a signal sound generated when a dial button is pressed on the telephone, such as a touch-tone phone. The DTMF combines four kinds of high-pitched sounds and four kinds of low-pitched sounds, and thus may express sixteen kinds in total, typically including numerals “0”-“9”, “*”, “#”, and alphabetical characters “A”-“D”. In the present embodiment, the CODEC 240 detects whether an asterisk key “*” has been entered from the telephone 10.

The DSP 250 can convert and superimpose a voice signal digitized by the CODEC 240 onto a packet for a packet network such as the Ethernet 2 on a real time basis, and extract a voice signal from a packet received from the packet network 2.

The CPU 260 can be a processor such as a CPU or an MPU, so as to control the components in the line switching apparatus 200. The memory 262 can include a RAM (Random Access Memory) for temporarily storing data read from a ROM (Read Only Memory) and data to be written into a storage (not shown), and a ROM for storing a line switching method, which will be described later, as well as various types of software and firmware for operations to be performed by the CPU 260.

The network controller 270, e.g., Ethernet controller, allows the network devices 20 shown in FIG. 1 to communicate via the network 2, and can control each part such that the telephone 10 may communicate using the VoIP.

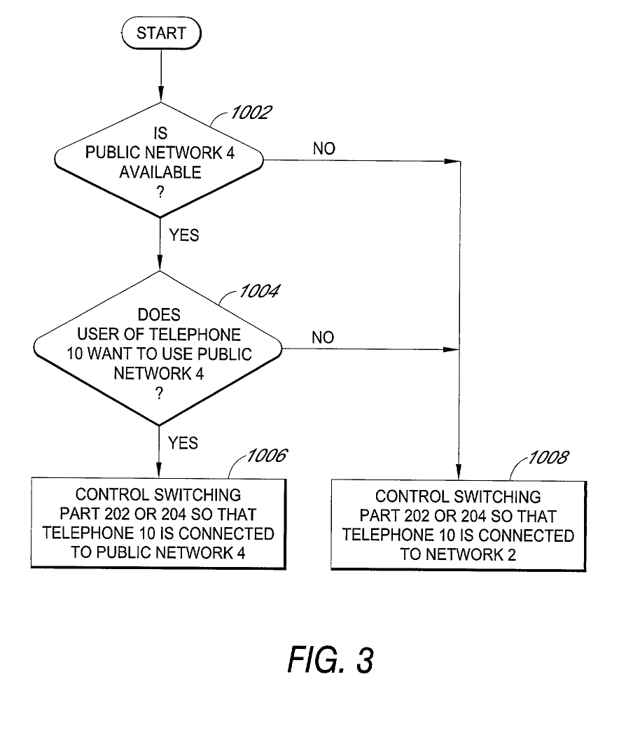

FIG. 3 is a flowchart illustrating a method of operation for (the CPU 260 in) the line switching apparatus 200, wherein the method is stored in the memory 262. Referring now to FIG. 3, the CPU 260 can recognize that a user attempts to use the telephone 10B by receiving a detection result from the SLIC 234 that has detected an ‘off-hook’ state. Next, in a state 1002, the CPU 260 determines whether the public network 4 is available. The CPU 260 may determine that the public network 4 is not in use by receiving a detection result from the SLIC 232 that has detected an ‘on-hook’ state for the telephone 10A.

In this way, the switching parts 202, 204 have been connected to sides of the SLIC's 232, 234 in advance.

If the CPU 260 determines that the public network 4 is available in state 1002, then the CPU 260 determines whether a user of the telephone 10B wishes to use the public network 4 in a state 1004. This determination relies upon whether the CODEC 240 detects an entry of the asterisk from the telephone 10B using the AID conversion. When the CPU 260 determines that the user of the telephone 10B wishes to use the public network 4 in state 1004 (entry of an asterisk before the phone number), in a state 1006 the CPU 260 controls switching of the switching part 204 so as to connect the telephone 10B to the public network 4. Thereby, the user of the telephone 10B may use the public network 4 for telephone communication. As a result, the user may execute the telephone communication while maintaining services, such as communication during a discount time period or a holding service in response to an interruption, for the public network 4.

In state 1004, when the CODEC 240 does not detect an entry of the asterisk and immediately detects a phone number for the VoIP, the CPU 260 determines that the user does not wish to use the public network 4. As a result, in a state 1008, the CPU 260 maintains switching with the switching part 204 such that the telephone 10B is connected to the network 2. The user of the telephone 10B may use the network 2 as an inexpensive method of telecommunication by converting the voice signal into a digital signal through the CODEC 240 and DSP 250. Thus, the user of the telephone 10B may select either of the public network 4 and the network 2 for communication.

In an alternate situation, it is assumed that the telephone 10A is using the public network 4. The CPU 260 may recognize such a case, for example, by the knowledge that it has already controlled the switching part 202 such that the telephone 10A is connected to the public network 4 in a procedure similar to that described above. When the telephone 10A is using the public network 4, in state 1002 the CPU 260 determines that the telephone 10B cannot use the public network 4, and the procedure goes to state 1008.

In the present scenario, when the CODEC 240 detects an entry of the asterisk after the SLIC 234 detects the ‘off-hook’ state, the CPU 260, for example, can control the DSP 250 such that a busy signal is supplied to the telephone 10B. Consequently, the user of the telephone 10B can recognize that the public network 4 is unavailable, hang up the telephone 10B, and repeats an action to connect the telephone 10B to the network 2.

As described above, when the user enters the VoIP number without entering the asterisk to select the public network 4, the CPU 260 controls the switching part 204 such that the telephone 10B is connected to the network 2 (state 1008). Thereby, the user of the telephone 10B may obtain an inexpensive telecommunication using the network 2. However, when the user wishes to use the public network 4 at any cost, they can wait for the telephone 10A to discontinue use of the public network 4. This enables the user of the telephone 10B to select a desired one of the public network 4 and the network 2.

The line switching apparatus 200 thus uses the mechanical switching parts 202, 204 to inexpensively switch a line to be connected to the telephone 10 (i.e., between the public network 4 and the network 2). The mechanical switching parts 202, 204 may maintain various services for which users of the telephones 10 apply in view of the public network 4.

A description will now be given of a procedure during a failure of power supplied to the network system 1. During the power supply failure, the switching parts 202, 204 can be connected to the public network 4 as described above. Then, since the SLIC's 232, 234 and subsequent components do not receive power, the telephone 10 may obtain telephone communication using the public network 4 by entering a normal telephone number. More particularly, other than during the failure of power supply, the telephone 10 communicates via the public network 4 after entering the asterisk (*) followed by a telephone number, while during a power supply failure, the telephone communicates via the public network 4 without an entry of the asterisk. Therefore, the telephone function is maintained even during a power supply failure.

The network device 20A-C connected to the network device 100A may communicate with the network device 20D-F of the other network device 100B via the Ethernet controller 270. In addition, the network device 20A-C connected to the network device 100A may communicate with another network device 20A-C connected to the network device 100A.

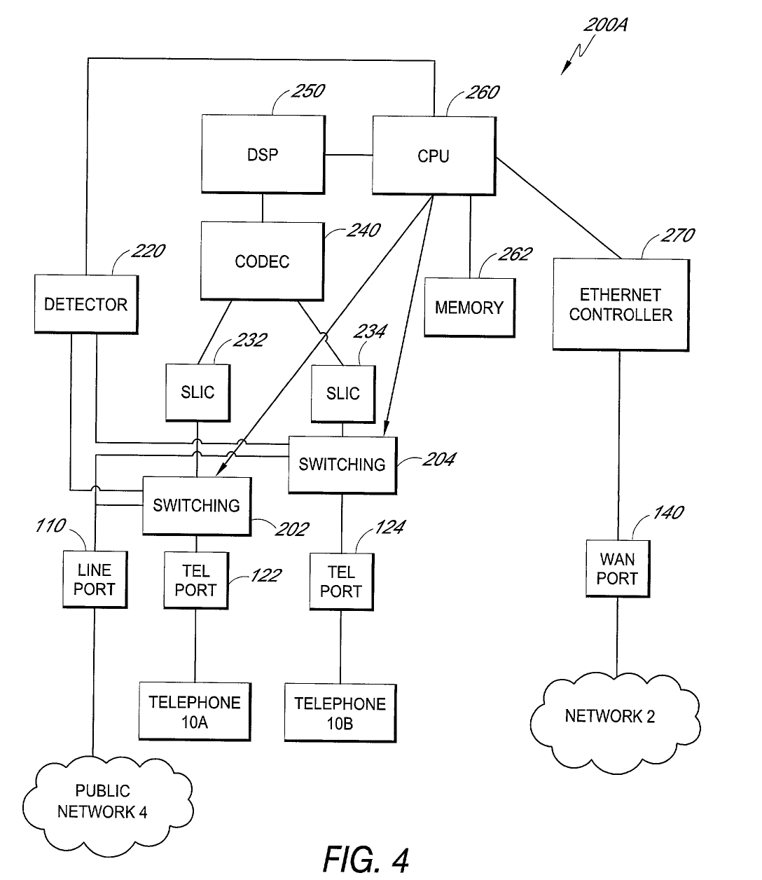

FIG. 4 is a block diagram of the line switching apparatus 200A applicable to the network device 100 shown in FIG. 1. Referring now to FIG. 4, a description will now be given of the line switching apparatus 200A of another embodiment for assigning either the network 2 or the public line 4 to the telephone 10. As illustrated, the line switching apparatus 200A includes, in addition to the above ports 110, 122, 124, and 140, the switching parts 202, 204, a detector 220, the SLIC's 232, 234, the CODEC 240, the DSP 250, the CPU 260, the memory 262, and the Ethernet controller 270. The elements in FIG. 4, which are the same as corresponding elements in FIG. 2, are designated by the same reference numerals and a description will be omitted.

The detector 220 is connected to the switching parts 202, 204, and detects a connection status, an ‘on-hook’ state, and a ‘ringing’ of the telephone 10. Normally, to the telephone 10, the calling voltage −48V is applied during the ‘on-hook’ state, 5V applied during the ‘off-hook’ state and during a calling time, and AC 75V applied during the ‘ringing’ time. The detector 220 in this embodiment detects the status of the telephones 10 through the switching parts 202, 204 by monitoring the voltage applied to them. The detector 220 detects whether a ringing is sent to the telephone 10 through the public network 4, thereby avoiding a contradiction of line where when the other telephone 10A receives a ringing, a user of the telephone 10B selects the public network 4.

The switching apparatus does not exclude monitoring of mechanical connection statuses by the switching parts 202, 204 in addition to or in place of monitoring communication traffic amounts at the switching parts 202, 204. In other words, the switching parts 202, 204 connect the telephones 10 to the network 2 in one embodiment, and the telephone 10 is connected to the public network 4 only when it communicates through the public network 4. Therefore, when the detector 220 detects that the switching part 202, 204 has connected the telephone 10 to the public network 4, the public network 4 may be considered in use.

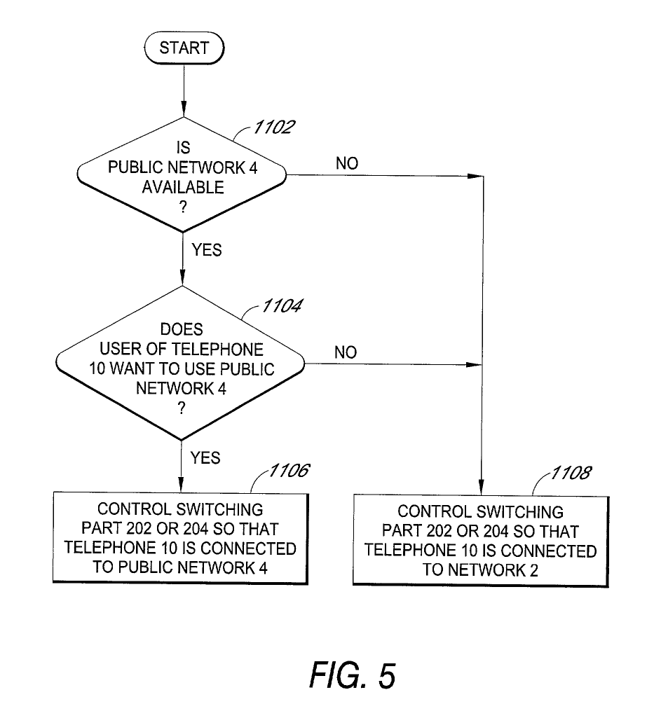

FIG. 5 is a flowchart illustrating a method of operation for (the CPU 260 in) the line switching apparatus 200A, which is stored in the memory 262. Referring now to FIG. 5, the CPU 260 recognizes that a user attempts to use the telephone 10B by receiving a detection result from the SLIC 234 that has detected an ‘off-hook’ state. Thus, in a state 1102, the CPU 260 determines whether the public network 4 is available. It is assumed that the telephone 10A is not using the public network 4. The CPU 260 may be aware of this by receiving a detection result from the SLIC 232 that has detected an on-hook state. In this case, the switching parts 202, 204 must have been connected to the sides of the SLIC's 232, 234 in advance. However, in one embodiment, the CPU 260 recognizes that from the detector 220 detecting 5V is not applied (for example, −48V is applied) to the switching part 202. In this case, the switching parts 202, 204 may have been connected to the sides of the SLIC's 232, 234 or the public line 4.

When the CPU 260 determines that the public network 4 is available in state 1102, then, in a state 1104 the CPU 260 determines whether a user of the telephone 10B wishes to use the public network 4. This determination relies upon whether the CODEC 240 detects an entry of the asterisk using the A/D conversion. When the CPU 260 determines that the user of the telephone 10B wishes to use the public network 4 in state 1104, in a state 1106 the CPU 260 controls switching via the switching part 204 such that the telephone 10B is connected to the public network 4. Thereby, the user of the telephone 10B may use the public network 4 for telephone communication. As a result, the user may execute the telephone communication while maintaining services (such as communication during a discount time period or a holding service in response to an interruption) for the public network 4.

When the CODEC 240 does not detect an entry of the asterisk and immediately detects a phone number for the VoIP, the CPU 260 determines that the user does not wish to use the public network 4 in state 1104. As a result, in a state 1108, the CPU 260 maintains control of switching by the switching part 204 such that the telephone 10B is connected to the network 2. The user of the telephone 10B may use the network 2 as an inexpensive method of telecommunication by converting the voice signal into a digital signal through the CODEC 240 and DSP 250.

Thus, the user of the telephone 10B may select either the public network 4 or the network 2 for communication using the method described with respect to FIG. 5.

In an alternate situation, it is assumed that the telephone 10A is using the public network 4. The CPU 260 may recognize such a case, for example, by the fact that it has already controlled the switching part 202 such that the telephone 10A was connected to the public network 4 in a procedure similar to that described above. Alternatively, the CPU 260 may recognize that the telephone 10A is using the public network 4 by notification from the detector 220 detecting 5V, indicative of the ‘off-hook’ state or calling state. When the telephone 10A is using the public network 4, the CPU 260 determines that the telephone 10B cannot use the public network 4 in state 1102. Therefore, the procedure goes to state 1008.

Alternately, the public network 4 may be unavailable when the telephone 10A does not perform a telephone communication via the public network 4 but when a ‘ringing’ is sent to the telephone 10A. The CPU 260 may recognize such a case, wherein the detector 220 detects 75V AC, for example, indicative of the ‘ringing.’ Even in this case, the CPU 260 determines that the telephone 10B cannot use the public network 4 in state 1102. Therefore, the procedure goes to the state 1008.

In the present case, when the CODEC 240 detects an entry of the asterisk after the SLIC 234 detects the ‘off-hook’ state, the CPU 260, for example, can control the DSP 250 such that a busy signal is supplied to the telephone 10B. Consequently, the user of the telephone 10B recognizes that the public network 4 is unavailable, hangs up the telephone 10B and repeats an action to connect the telephone 10B to the network 2. As described above, when the user enters the VoIP number without entering the asterisk to select the network 2, the CPU 260 controls the switching part 204 such that the telephone 10B is connected to the network 2 in state 1108. Thereby, the user of the telephone 10B may obtain an inexpensive telecommunication using the network 2. Of course, when the user wishes to use the public network 4 at any cost, he/she can wait for an end of use of the public network 4 by the telephone 10A. This enables the user of the telephone 10B to select a desired one of the public network 4 and the network 2.

The line switching apparatus 200 thus uses the mechanical switching parts 202, 204 to inexpensively switch a line to be connected to the telephone 10 between the public network 4 and the network 2. The mechanical switching parts 202, 204 may maintain various services for which users of the telephones 10 apply in view of the public network 4.

The procedure during the failure of power supply is the same as described for the previous embodiment, and thus a description thereof will be omitted.

In an alternate embodiment, the network device 20A-C, connected to the network device 100A, may communicate with the network device 20D-F of the other network device 100B via the Ethernet controller 270. In addition, the network device 20A-C connected to the network device 100A may communicate with the other network device 20A-C connected to the network device 100A.

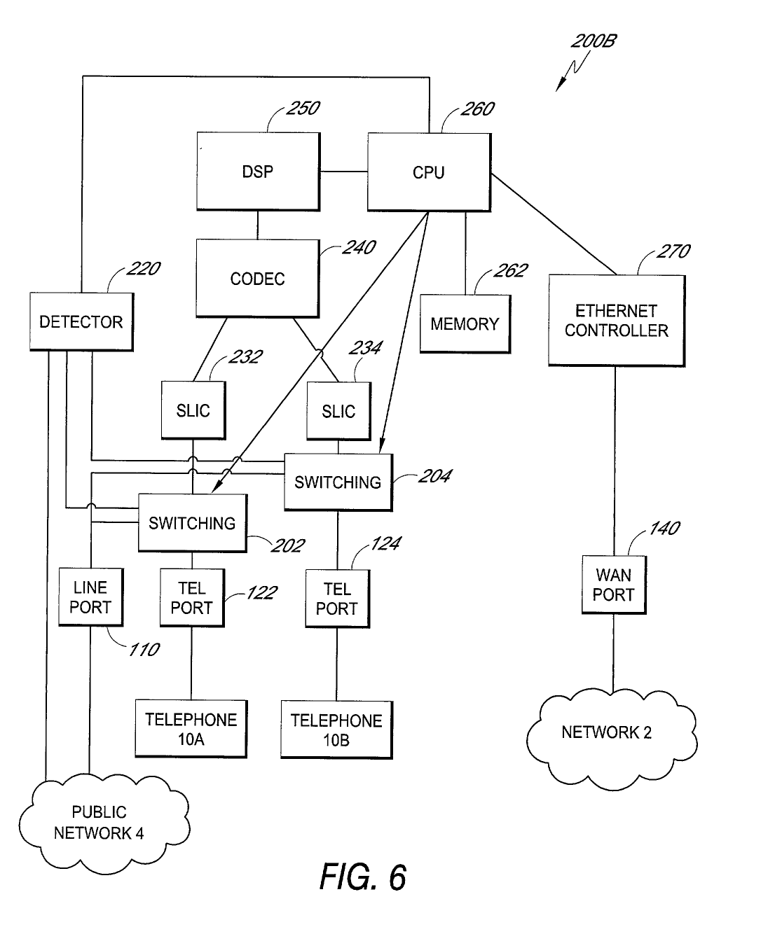

FIG. 6 is a block diagram of the line switching apparatus 200B, applicable to the network device 100 shown in FIG. 1. Referring now to FIG. 6, a description will be given of one embodiment of the line switching apparatus 200B configured to assign either the network 2 or the public line 4 to the telephone 10. As illustrated, the line switching apparatus 200B comprises, in addition to the previously described ports 110, 122, 124, 140, the switching parts 202, 204, a detector 222, the SLIC's 232, 234, the CODEC 240, the DSP 250, the CPU 260, the memory 262, and the Ethernet controller 270. Those elements in FIG. 6, which are the same as corresponding elements in FIG. 2, are designated by the same reference numerals and a description thereof is omitted.

The detector 222 is connected to the public network 4 and switching parts 202, 204, and can be structured as a DTMF (Dual Tone Multi Frequency) receiver for detecting a specific key entered from the telephone 10. The detector 222 can be configured to detect the asterisk of the telephone 10, for example, and may be a known pulse tone circuit.

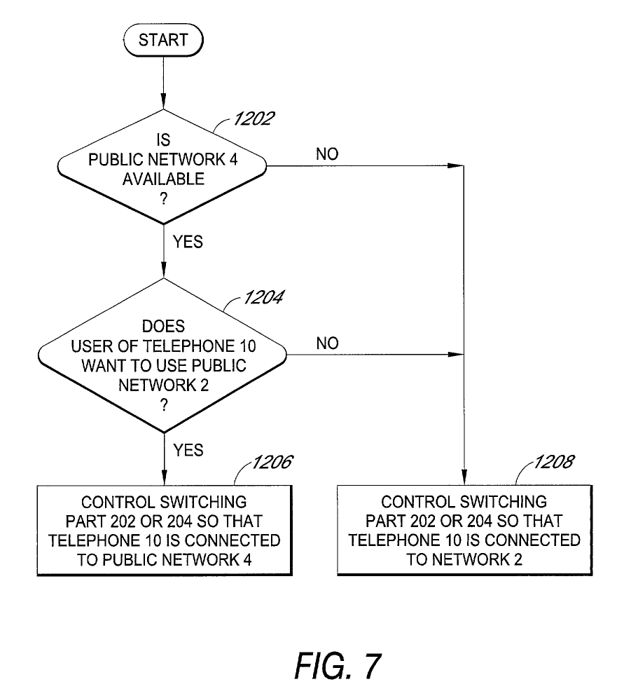

FIG. 7 is a flowchart illustrating a method of operation for (the CPU 260 in) the line switching apparatus 200B, wherein the method is stored in the memory 262. Referring now to FIG. 7, the CPU 260 recognizes that a user attempts to use the telephone 10B by receiving a detection result from the SLIC 234 that has detected an ‘off-hook’ state. Thus, in a state 1202, the CPU 260 determines whether the public network 4 is available. It can be assumed in the present case that the telephone 10A is not using the public network 4. The CPU 260 may be aware of such a case by receiving a detection result from the SLIC 232 that has detected an ‘on-hook’ state for telephone 10A. In the present case, the switching parts 202, 204 must have been connected to the sides of the SLIC's 232, 234 in advance.

When the CPU 260 determines that the public network 4 is available in state 1202, then, in a state 1204, the CPU 260 determines whether a user of the telephone 10B wishes to use the public network 2. This determination can rely upon whether the detector 210 detects an entry of the asterisk. In order to make this determination, the CPU 260 can switch the switching parts 202, 204 to the side of the public network 4 when the SLIC 232, 234 detects an ‘off-hook’ state.

When the CPU 260 determines that the user of the telephone 10B does not wish to use the public network 2 in state 1204, the CPU 260 controls switching with the switching part 204 such that the telephone 10B is connected to the public network 4 in a state 1206. The CPU 260 can determine that the user does not wish to use the public network 2 when the detector 210 readily detects a phone number without detecting an entry of the asterisk. Thereby, the user of the telephone 10B may use the public network 4 for telephone communication. As a result, the user may execute telephone communication while maintaining services (such as communication during a discount time period or a holding service in response to an interruption) for the public network 4. Thus, the present embodiment determines whether the network 2, rather than the public network 4, is to be connected.

Such a structure can eliminate the necessity of the user of the telephone 10 to enter a key other than a destination number unless the user wishes to use the network 2. Therefore, the user may perform a telephone communication via the public network by simply entering a phone number. Such a phone number without a prefix can be convenient, especially in entering a number in case of emergency. For example, in the event of an emergency such as fire, it is preferable to use a number with no prefix before 91 1.

Alternately, when the detector 210 detects entry of the asterisk, the CPU 260 determines that the user of the telephone 10B wishes to use the network 2 (state 1204). As a result, in a state 1208, the CPU 260 maintains control of the switching via the switching part 204 such that the telephone 10B is connected to the network 2. The user of the telephone 10B may use the network 2 for inexpensive telecommunication by converting a voice signal into a digital signal through the CODEC 240 and DSP 250. Thus, the user of the telephone 10B may select a desired one of the public network 4 and the network 2.

In an alternate case, it is assumed that the telephone 10A is using the public network 4. The CPU 260 may recognize such a case, for example, by recognizing that it has already controlled the switching part 202 such that the telephone 10A is connected to the public network 4 in a procedure similar to that described above. In the case where the telephone 10A is using the public network 4, the CPU 260 determines that the telephone 10B cannot use the public network 4 in state 1202. Therefore, the procedure goes to state 1208.

In yet another case, the public network 4 is unavailable when the telephone 10A does not perform a telephone communication through the public network 4, but when a ‘ringing’ is sent to the telephone 10A. The CPU 260 may recognize such a case wherein the detector 220 detects 75V AC, indicative of the ‘ringing.’ Even in the present case, the CPU 260 determines that the that the telephone 10B cannot use the public network 4 in state 1202. Therefore, the procedure goes to state 1208.

In this case, when the CODEC 240 detects an entry of the asterisk after the SLIC 234 detects the ‘off-hook’ state, the CPU 260, for example, can control the DSP 250 such that a ‘busy’ signal is supplied to the telephone 10B. Consequently, the user of the telephone 10B recognizes that the public network 4 is unavailable, hangs up the telephone 10B and repeats an action to connect the telephone 10B to the network 2. As described above, when the user enters the asterisk to select the network 2, the CPU 260 controls the switching part 204 such that the telephone 10B is connected to the network 2 in state 1208. Thereby, the user of the telephone 10B may obtain inexpensive telecommunication means using the network 2. However, when the user wishes to use the public network 4 at any cost, they can wait for an end of use of the public network 4 by the telephone 10A. This enables the user of the telephone 10B to select either the public network 4 or the network 2 for communication.

The line switching apparatus 200 thus uses the mechanical switching parts 202, 204 to inexpensively switch a line to be connected to the telephone 10 (i.e., between the public network 4 and the network 2). The mechanical switching parts 202, 204 may maintain various services for which users of the telephones 10 apply in view of the public network 4.

A description will now be given of a procedure during the failure of power supplied to the network system 1. During a power supply failure, the switching parts 202, 204 are connected to the sides of the public network 4 as described above. Then, since SLIC's 232, 234 and subsequent components do not receive power, the telephone 10 may obtain telephone communication via the public network 4 by entering a normal telephone number. Thus, during a power supply failure, and other than during the failure of power supply, the telephone 10 communicates via the public network 4 by directly entering a phone number without the asterisk. Therefore, the telephone function is maintained, even during a power supply failure.

Alternately, the network device 20 connected to the network device 100A may communicate with the network device 20 of the other network device 100B through the Ethernet controller 270. Of course, the network device 20 connected to the network device 100A may communicate with the other network device 20 connected to the network device 10A.

Further, the present invention is not limited to the embodiments shown and described, and various modifications and variations may be made without departing from the scope of the invention. For example, a type of the network device 100 is not limited to a switch and may be a router.

The inventive line switching method and apparatus, and network device thus may freely switch between a public line (e.g., a telephone network) and a line other than the public network, such as a VoIP, ISDN, and a SDH, in accordance with user's will. It will be appreciated, that no matter how detailed the foregoing appears in text, the invention can be practiced in many ways. It should also be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of assigning one of a public network and a digital communication network different from the public network to a communication apparatus having a telephone function, the method comprising:
determining whether the public network is available;
determining whether a user of the communication apparatus desires to connect the communication apparatus to the public network or the digital communication network;
connecting the communication apparatus to the public network if in the determining of network availability the public network is available, and if in the determining of connection the user desires to connect the communication apparatus to the public network; and
connecting the communication apparatus to the digital communication network if in the determining of network availability the public network is unavailable or if in the determining of connection the user desires to connect the communication apparatus to the digital communication network.

2. The method of claim 1, wherein the communication apparatus includes a key entry part, and determining whether a user of the communication apparatus desires to connect the communication apparatus to the public network or the digital communication network is based on, at least in part, an entry of a specific key at the communication apparatus.

3. The method of claim 1, further comprising allowing the communication apparatus to communicate using a Voice over Internet Protocol when the communication apparatus is connected to the digital communication network.

4. The method of claim 1, wherein determining whether the public network is available further comprises determining a state of the communication apparatus, the state including a ringing to the communication apparatus.

5. A line switching apparatus comprising:
a switching part, configured to mechanically switch a line between a first network and a second network, wherein the line is connected to a communication apparatus; and
a control part configured to control the switching part, wherein the communication apparatus is connected to the first network when the control part determines that the first network is available, and to the second network when the control part determines that the first network is unavailable.

6. The line switching apparatus of claim 5, wherein the first network is a switched network, the second network is a packet switched communication network, and the communication apparatus has a telephone function.

7. The line switching apparatus of claim 6, wherein the line switching apparatus further comprises a digitization part for digitizing a voice signal entered from the communication apparatus so as to transfer the voice signal through the second network.

8. The line switching apparatus of claim 5, wherein the control part determines whether a user of the communication apparatus wishes to connect the communication apparatus to the first network, and the control part controls the switching part so that the communication apparatus is connected to the first network when the control part determines that the user wishes to connect the communication apparatus to the first network.

9. The line switching apparatus of claim 6, wherein the line switching apparatus further comprises a detector for detecting a state of the communication apparatus through said switching part, the state including a ringing to the communication apparatus, and wherein the control part determines an availability of the switched network based on a detection result from the detector.

10. The line switching apparatus of claim 9, wherein the state further includes an ‘on-hook’ state of the communication apparatus.

11. The line switching apparatus of claim 9, wherein the state further includes a ‘calling’ state of the communication apparatus.

12. The line switching apparatus of claim 5, wherein the line switching apparatus further comprises a detector, connected to the switching part and the first network, configured to detect a specific key entered from the communication apparatus, wherein the control part determines, based on a detection result from the detector, whether a user of the communication apparatus wishes to connect the communication apparatus to the second network.

13. The line switching apparatus of claim 12, wherein the control part controls the switching part such that the communication apparatus is connected to the first network when the control part determines that the user does not wish to connect the communication apparatus to the second network, and wherein the control part controls the switching part such that the communication apparatus is connected to the second network when the control part determines that the user wishes to connect the communication apparatus to the second network.

14. The line switching apparatus of claim 12, further comprising an additional detector for detecting an ‘on-hook’ state and an ‘off-hook’ state of the communication apparatus.

15. The line switching apparatus of claim 14, wherein the additional detector is a subscriber line interface circuit.

16. The line switching apparatus of claim 5, further comprising:
a first detector configured to detect an ‘on-hook’ state and an ‘off-hook’ of the communication apparatus; and
a second detector configured to detect an entry of a specific key from the communication apparatus, wherein the control part determines, based on detection results from the first and second detectors, whether a user of the communication apparatus wishes to connect the communication apparatus to a public communication network.

17. The line switching apparatus of claim 16, wherein the first detector is a subscriber line interface circuit.

18. The line switching apparatus of claim 16, wherein the second detector is a CODEC.

19. The line switching apparatus of claim 16, wherein the second detector has a digitization part for digitizing a voice signal entered from the communication apparatus so as to transfer the voice signal through the second network.

20. The line switching apparatus of claim 5, wherein the first network is a public network and the second network is a digital communication network, and wherein the line switching apparatus further comprises:
a first detector configured to detect an ‘on-hook’ state and ‘off-hook’ state of the communication apparatus; and
a second detector configured to detect an entry of a specific key from the communication apparatus, wherein the control part controls the switching part so that the communication apparatus is connected to the first network when the control part determines that the first network is available and when the second detector detects the specific key entered from the communication apparatus, and wherein the control part controls the switching part so that the communication apparatus is connected to the second network when the control part determines that the first network is unavailable or when the second detector does not detect the specific key entered from the communication apparatus.

21. The line switching apparatus of claim 20, wherein the first detector is a subscriber line interface circuit.

22. The line switching apparatus of claim 20, wherein the second detector is a CODEC.

23. The line switching apparatus of claim 20, wherein the second detector includes a digitization part for digitizing a voice signal entered from the communication apparatus so as to transfer the voice signal through the second network.

24. A network device, comprising:
a first port, configured to connect to a first communication apparatus having a telephone function;
a second port, configured to connect to a second communication apparatus which is a different type from the first communication apparatus, wherein the second port allows the second communication apparatus to communicate using a digital communication network;
a third port, configured to connect to a public network for sending a voice signal obtained from the telephone function of the first communication apparatus;
a digitization part configured to digitize the voice signal from the first communication apparatus, thereby allowing the voice signal to be transferred via the digital communication network;
a switching part, connected to the first communication apparatus, configured to mechanically assign the public network or the digital communication network to the first communication apparatus; and
a control part, configured to control the switching part such that the communication apparatus is connected to the public network when the control part determines that the first network is available and that a user of the first communication apparatus wishes to use the public network, and such that the communication apparatus is connected to the digital communication network when the control part determines that the public network is unavailable or that the user does not wish to connect the communication apparatus to the public network.

25. The network device of claim 24, wherein the network device includes at least two first ports.

26. The network device of claim 24, further comprising a detector configured to detect a state, including a ‘ringing’ state of the communication apparatus, through said switching part, wherein the control part determines an availability of the public network based on a detection result of the detector.

27. The network device of claim 23, further comprising a detector, connected to the switching part and the public network, configured to detect a specific key entered from the communication apparatus, wherein the control part determines whether a user of the communication apparatus wishes to connect the communication apparatus to the second network based on a detection result from the detector.

28. A method of assigning one of a first network and a second network to a communication apparatus, the method comprising:
determining whether the first network is available;
determining whether a user of the communication apparatus wishes to connect the communication apparatus to the first network;
connecting the communication apparatus to the first network when the determining of network availability determines that the first network is available and when the determining of connection determines that the user wishes to connect the communication apparatus to the first network; and
connecting the communication apparatus to the second network when it is determined that the public network is unavailable or when it is determines that the user does not wish to connect the communication apparatus to the first network.
